(19) United States
(12) Patent Application Publication
(10) Pub. No.: US 2006/0131120 A1
(43) Pub. Date: Jun. 22, 2006

(54) Device for transmitting the movement to fans for cooling engines

(75) Inventor: Piercarlo Boffelli, Milano (IT)

Correspondence Address: SEYFARTH SHAW LLP, 55 E. MONROE STREET, SUITE 4200, CHICAGO, IL, 60603-5803, US

(73) Assignee: Baruffaldi S.p.A.

(21) Appl. No.: 11/230,118

(22) Filed: Sep. 19, 2005

(30) Foreign Application Priority Data
Sep. 22, 2004 (IT) MI2004A 001813

(51) Int. Cl. F16D 27/08

(52) U.S. Cl. 192/48.2

(57) ABSTRACT

Device for transmitting the movement to a fan for cooling the coolant in a motor vehicle, comprising a fixed support shaft and movement generating means on which the fan is mounted by means of an idle support; a first electromagnetic clutch, the rotor of which is integral with said movement generating means and engagement of which causes rotation of the fan at a number of revolutions equal to that of the movement generating means, a second clutch, the rotor of which is mounted on said movement generating means and engagement/disengagement of which causes rotation of the fan at a lower number of revolutions or zero speed compared to that of the movement generating means; means of the electromagnetic type for engaging/disengaging the said second clutch; in which said first clutch is supported in a position substantially adjacent to the fixed base of the engine casing the said second clutch is supported by a fixed shaft in a position substantially projecting from the base of the engine, the engaging means of the second clutch being mounted on the said movement generating means.

The present invention relates to a device for transmitting the movement to fans for cooling the coolant in motor vehicles.

It is known in the technical sector relating to the cooling of coolants contained in motor-vehicle radiators that there exists the need to force air onto the radiator in order to obtain more rapid dissipation of heat from the coolant to the exterior, said forced air flow being obtained by causing rotation of a fan which is normally mounted either directly on the driving shaft or on the water pump shaft or on a driven and fixed shaft carrying a pulley which receives movement from a belt actuated by the driving shaft. It is also known that said fan must be made to rotate only upon reaching a certain predefined temperature of the water detected by means of a thermostat which activates an electromagnetic clutch, closing of which causes the fan to start rotating.

More particularly it is required that a motor vehicle fan must be able to rotate:

at a lower speed than that of the transmission shaft for cooling in low external temperature conditions;

at a speed equal to or even greater than that of the transmission shaft in the case of higher external temperatures or use in severe conditions which cause overheating of the engine;

at zero speed, namely with the fan which does not rotate at all and remains in an idle condition with respect to the transmission shaft, in the case of particularly low temperatures at which further cooling is of no use or even damaging.

In an attempt to achieve these performance features, coupling systems of the mixed type with electromagnetically operated friction clutches and drive couplings based on the use of parasitic currents generated by rotation of a conducting element in the vicinity of permanent magnets have been developed.

DE-32 03 143 describes, for example, an arrangement in which the driving shaft is connected to the rotor of an electromagnetic clutch, which is engaged by an armature connected to the fan for direct driving, whereas low speed conditions make use of the engagement between a conducting disk, rotating with the transmission shaft, and the permanent magnets integral with the fan, said engagement causing transmission of movement at a low speed as a result of relative slipping between the two parts. With this solution, however, it is not possible to obtain the idle condition of the fan.

In order to overcome this drawback, EP-1,130,232, in the name of the same present Applicants, described a device for transmitting the movement to a fan for cooling the coolant in a motor vehicle, comprising movement generating means on which the fan is mounted by means of an idle support, a first electromagnet clutch, engagement/disengagement of which causes a rotation of the fan at a number of revolutions equal to that of the movement generating means or at zero speed; a second clutch, engagement/disengagement of which causes a rotation of the fan at a number of revolutions less than or at zero speed compared to that of the movement generating means; means of the electromagnet type for engagement/disengagement of the said second clutch, in which said first clutch is supported in a position substantially adjacent to the fixed base of the engine casing and said second clutch is supported by a shaft fixed in a position substantially projecting with respect to the base of the engine.

Although fulfilling its function, this device, however, has drawbacks arising from the fact that the small air gap present between the rotor of the second clutch and the fixed electromagnet may result in abnormal wear in the event of accidental contact due either to the vibrations transmitted by the movement generating part integral with the internal-combustion engine or to the tolerances as regards the concentricity of the coaxial parts in relative movement.

In addition, the known device does not envisage the possibility of maintaining an albeit slow rotation of the fan in the case of breakage and/or complete interruption of the power supply to the coils of the clutches as occurs for example in the case of total electrical failure.

The technical problem which is posed, therefore, is that of providing a device for transmitting the rotational movement to a fan for cooling the coolant of motor vehicles, which allows the fan to rotate at a number of revolutions which can be determined depending on the actual cooling requirement of the engine, including also the possibility of keeping the fan stationary in an idle position, which has compact dimensions and does not have large and costly projecting rotational masses, which is formed by a small number of costly parts and which is able to ensure reliable rotation of the fan also in the case of malfunction of the power supply and control devices.

These technical problems are solved according to the present invention by a device for transmitting the movement to a fan cooling the coolant of a motor vehicle, according to the characteristic features of claim 1.

Further details may be obtained from the following description of a non-limiting example of embodiment of the invention, provided with reference to the accompanying drawings in which:

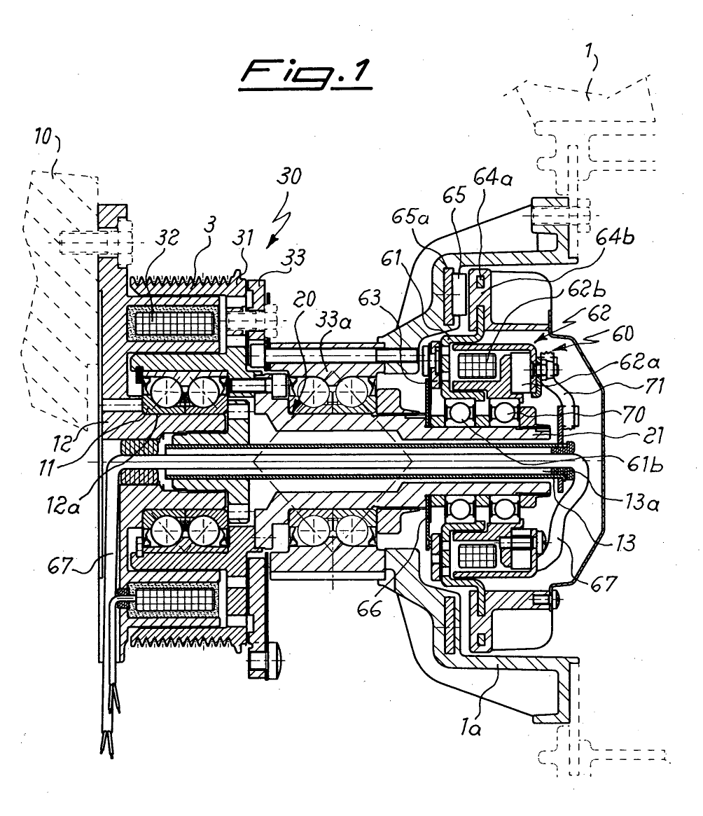

FIG. 1 shows a schematic axial section through the device for transmitting the movement to the fan according to the present invention.

As shown in FIG. 1, the device for transmitting the movement to a cooling fan 1 for moor vehicles is arranged between the fan 1 itself and actuating means 20 integral with a pulley 3 connected to the driving shaft by means of a belt (not shown). For the sake of convenience of the description below, “longitudinal direction” will be understood as meaning that direction coinciding with/parallel to the longitudinal axis of the actuating means 20.

In greater detail the actuating means comprise a hollow sleeve 21, one end of which is connected to a rotor 31 integral with the pulley 3 and mounted on a bearing 11 keyed onto a seat 12a of a fixed support flange 12 integral with the base 10 of the engine.

Said flange 12 has a longitudinal extension towards the exterior, which forms a fixed spindle 13 with an inner through-cavity 13a through which electrical wires 67 may be passed.

Said rotor 31 forms the rotating element of a first clutch 30 formed by an annular electromagnet 32 concentric with the rotor 31 and arranged between the latter and the fixed flange 12 and electrically connected to a thermostat (not shown) for example for the cooling-water temperature.

The armature 33 of the clutch 30 is arranged on the opposite side to the electromagnet 32 with respect to the rotor 31 and is connected to the thrust piece of a bearing 33a in turn keyed onto the hollow sleeve 21, a bell 1a which supports the fan 1 also being coupled to the said thrust piece.

On the free end of the hollow sleeve 21 there is mounted a second clutch 60 of the induction type which is based on Foucault currents or parasitic currents and engagement of which is obtained by associated means consisting of a second annular electromagnet 62 in turn coaxially mounted on the hollow sleeve 21 by means of a bearing 70 arranged between and concentrically inserted in a special annular seat 61a of the rotor 61 of the second clutch 60.

Said rotor 61 is in turn mounted on an associated bearing 61 keyed onto the sleeve 21.

The armature 63 of the second clutch is arranged on the opposite side to the rotor 61 with respect to the electromagnet 62 and is locked in rotation with the sleeve 21 by means of an elastic membrane 66 able to allow the displacement of the armature in the axial direction, but not its rotation about the longitudinal axis.

The electromagnet 62 is of the type with a permanent magnet 62a which constantly attracts the armature 63 until the controlled energisation of the coil 62b neutralizes the magnetic field of the magnet 62a.

As mentioned, the second clutch 60 is of the induction type based on parasitic or Foucault currents and comprises a plurality of permanent magnets 65 which are supported by a retaining ring 65a made of non-magnetic material and integral with the bell 1a, and a ring 64a made of conductive material and forming an annular part of the rotor 61 on which a non-magnetic element 64b, for example made of aluminium, is integrally cast.

In this way the ring 65a and the magnets 65 form the induction linkage elements with the annular part 64a of the rotor for causing rotation of the bell 1a and therefore the fan 1.

The operating principle of the coupling is as follows:

if both the electromagnet 32 and the coil 62b of the second clutch 60 are kept deactivated, the armature 33 of the first clutch 30 remains separated from the rotor 31, while the armature 63 of second clutch 60, recalled by the magnet 62a, engages with the rotor 61 which, starting to rotate, causes linkage of the second clutch 60 with the bell 1a and the consequent rotation of the fan 1; said rotation produces the formation of parasitic induction currents between the elements 64a and 65a of the clutch 60 which causes rotation of the bell 1a and therefore the fan 1.

Since driving of the bell by means of the rotor 61 occurs with relative slipping, the fan will rotate at a speed lower than that of the sleeve 21.

if the electromagnet 32 of the first clutch 30 is activated, the armature 33 is recalled into contact with the rotor 31, together with which it starts to rotate, causing the rotation of the bell 1a, and therefore the fan 1, at a number of rotations equal to that of the actuating pulley 3;

if the coil 62b of the second clutch is excited, deactivating the electromagnet 32 of the first clutch 30, both the armatures 33 and 63 of the respective clutches remain detached from the associated rotor 31/61 and consequently the bell 1a and therefore the fan 1 remain stationary in the idle condition with respect to the sleeve 21 generating the movement.

In the event of total failure or interruption in the electric power supplying the electromagnets 32 and 62, the magnet 62a of the second clutch attracts the armature 63, causing movement of the rotor 61 which, by means of the clutch 64, maintains an albeit minimum rotation of the fan (so-called “Fail Safe” effect), allowing the vehicle to be driven without assistance to a service centre.

It is therefore pointed out how the transmission device according to the invention is able to produce the three required rotational speeds of the fan (number of revolutions equal to/less than/zero compared to the movement generating shaft) as well as a slow safety rotation without large rotating loads projecting on the fixed support, since the electromagnet of the second clutch may have much smaller dimensions and ensure improved safety conditions since any defects in the concentricity and/vibrations transmitted by the internal-combustion engine would not have any effect on the correct rotation of the rotor of the second clutch. In other words, the fact of arranging all the rotating parts on the movement generating sleeve ensures the concentricity of the various parts which are all equally subject to the same stresses.

Although not shown, it is envisaged that the device according to the invention may be designed with a second clutch of the magnetic hysteresis type instead of the induction type.

In this case the permanent magnets supported by a ring are arranged on the rotor of the second clutch, while a ring of magnetically semi-hard material is coupled to the bell 1a.

The operating principle of the device remains substantially unchanged.

In the preferred embodiment shown in FIG. 1, it is envisaged moreover that:

the membrane 66 of the armature 63 of the second clutch 60 is directly coupled to the rotating sleeve 21;

the armature 33 of the first clutch 30 is directly fixed to the associated bearing 33a;

the connection between the magnet 62a of the second clutch and the fixed spindle 13 is performed by means of a non-rigid element 71, such as rubber or the like.

1. Device for transmitting the movement to a fan for cooling the coolant in a motor vehicle, comprising a fixed support shaft and
movement generating means on which the fan is mounted by means of an idle support;
a first electromagnetic clutch, the rotor of which is integral with said movement generating means and engagement of which causes rotation of the fan at a number of revolutions equal to that of the movement generating means;
a second clutch, the rotor of which is mounted on said movement generating means and engagement/disengagement of which causes rotation of the fan at a lower number of revolutions or zero speed compared to that of the movement generating means;
means of the electromagnetic type for engaging/disengaging the said second clutch, in which said first clutch is supported in a position substantially adjacent to the fixed base of the engine casing and said second clutch is supported by a fixed shaft in a position substantially projecting from the base of the engine, characterized in that the engaging means of the second clutch are mounted on the said movement generating means.

2. Device according to claim 1, characterized in that said first clutch and second clutch are arranged coaxially with a fixed support shaft and with each other.

3. Device according to claim 1, characterized in that said engaging means of the second clutch consist of an electromagnetic clutch.

4. Device according to claim 3, characterized in that said electromagnetic clutch comprises a permanent magnet and a coil with controlled excitation.

5. Device according to claim 4, characterized in that said magnet is mounted on the movement generating means with the arrangement of a bearing in between.

6. Device according to claim 4, characterized in that the support of the magnet is coupled to the fixed support shaft via elastic means.

7. Device according to claim 1, characterized in that the rotor of the second clutch is mounted on the movement generating sleeve via a bearing.

8. Device according to claim 1, characterized in that the conducting element of the second clutch consists of an armature integral with the movement generating means.

9. Device according to claim 8, characterized in that said armature is arranged on the opposite side to the rotor with respect to the electromagnet, said armature being locked in rotation with the movement generating means by means of an elastic membrane.

10. Device according to claim 1, characterized in that the rotor of the second clutch has a circumferential flange on which an annular element made of non-magnetic material is integrally cast.

11. Device according to claim 1, characterized in that said second clutch is of the parasitic-current type.

12. Device according to claim 1, characterized in that said second clutch is of the magnetic-hysteresis type.

13. Device according to claim 1, characterized in that the armature of the first clutch and the support bell of the fan are mounted on a support bearing keyed onto the movement generating sleeve.

14. Device according to claim 1, characterized in that said fixed support spindle is located coaxially inside the movement generating means which are in turn located coaxially inside the second clutch.

15. Device according to claim 1, characterized in that said fixed shaft has a coaxial through-cavity.

16. Device according to claim 15, characterized in that the electric wires for connection to the electromagnet of the second engaging clutch are arranged inside said coaxial through-cavity of the fixed shaft.
